(19) United States
(12) Patent Application Publication
(10) Pub. No.: US 2025/0333276 A1
(43) Pub. Date: Oct. 30, 2025

(54) BATTERY EXCHANGE CART

(71) Applicant: Isuzu Motors Limited, Yokohama-shi (JP)

(72) Inventor: Muneyuki OSAWA, Fujisawa-shi (JP)

(73) Assignee: Isuzu Motors Limited, Yokohama-shi (JP)

(21) Appl. No.: 19/058,085

(22) Filed: Feb. 20, 2025

(30) Foreign Application Priority Data
Apr. 30, 2024 (JP) 2024-073935

(51) Int. Cl. B66F 9/065; B60S 5/06; B66F 9/18

(52) U.S. Cl. CPC B66F 9/065; B66F 9/18; B60S 5/06

(57) ABSTRACT

A battery exchange cart according to the present disclosure is a battery exchange cart used for exchanging a battery, and including: wheels including at least a rear wheel and a front wheel; a frame part including: a bottom frame configured to connect between the wheels, and a vertical frame provided upright in a vertical direction from the bottom frame; and an arm unit including a battery holding arm protruding forward from the vertical frame and configured to hold a battery. The arm unit is supported by the vertical frame in a movable manner in an up-down direction and in a horizontal direction perpendicular to a traveling direction of the battery exchange cart.

### CROSS REFERENCE TO RELATED APPLICATIONS

This application claims the benefit of priority of Japanese Patent Application No. 2024-073935, filed on Apr. 30, 2024, the disclosure of which including the specification, drawings and abstract is incorporated herein by reference in its entirety.

### TECHNICAL FIELD

The present disclosure relates to a battery exchange cart used for exchanging a battery of a vehicle.

### BACKGROUND ART

In recent years, electric vehicles have been rapidly spreading. There are two main methods for charging the battery of an electric vehicle.

The first method is a method of directly charging a battery with electricity from a commercial power source or the like at a charging station. The second method is a method of exchanging a low battery with a charged battery.

The second method is suitable for cases where the battery capacity is large such as large vehicles (trucks, dump trucks, buses), for which the first method requires a long charging time, for example. In the related art, the second method is often performed at a battery exchange station (also referred to as a quick change station). Battery exchange stations are described in Patent Literatures 1 and 2, for example.

### CITATION LIST

### Patent Literature

### PTL 1

Japanese Unexamined Patent Application Publication (Translation of PCT Application) No. 2021-508432

### PTL 2

Japanese Unexamined Patent Application Publication (Translation of PCT Application) No. 2022-547117

### SUMMARY OF INVENTION

### Technical Problem

Battery exchange stations are designed to automatically exchange batteries, and require actuators to drive the arm that holds the battery, various sensors for moving the arm to a correct position and the like, and as such, their configuration tends to be complex. As a result, battery replacement stations have the disadvantage of large configurations and high initial investment.

Further, in order to perform battery exchange at a battery exchange station, it is necessary to drive the vehicle to a predetermined position at the battery exchange station. For this reason, it is difficult to exchange the battery for a vehicle that cannot travel to a battery exchange station due to battery depletion, for example.

One conceivable method for solving the above-described problem may be using a hand-pushed cart for battery exchange. However, a cart suitable for battery exchange has not been sufficiently considered.

The present disclosure has been made in view of the above points, and provides a battery exchange cart suitable for battery exchange.

### Solution to Problem

A battery exchange cart according to the present disclosure is a battery exchange cart used for exchanging a battery, and including: wheels including at least a rear wheel and a front wheel; a frame part including: a bottom frame configured to connect between the wheels, and a vertical frame provided upright in a vertical direction from the bottom frame; and an arm unit including a battery holding arm protruding forward from the vertical frame and configured to hold a battery. The arm unit is supported by the vertical frame in a movable manner in an up-down direction and in a horizontal direction perpendicular to a traveling direction of the battery exchange cart.

### Advantageous Effects of Invention

According to the present disclosure, it is possible to realize a battery exchange cart suitable for battery exchange.

### BRIEF DESCRIPTION OF DRAWINGS

FIG. 1 is a perspective view illustrating a configuration of a battery exchange cart according to an embodiment;

FIG. 2 is a top view of the battery exchange cart;

FIG. 3 is a side view of the battery exchange cart;

FIG. 4 is a perspective view illustrating a state in which the battery exchange cart is transporting a battery;

FIG. 5 is a front view of the battery exchange cart in a state where the arm unit is lowered to the lowermost position;

FIG. 6 is a front view of the battery exchange cart in a state where the arm is inserted below the battery;

FIG. 7 is an enlarged view illustrating a state in which an arm is inserted into a gap between a lower surface of a battery and a battery mounting surface; and

FIG. 8 is a perspective view of the battery exchange cart as viewed from an obliquely rear side.

### DESCRIPTION OF EMBODIMENTS

Hereinafter, one embodiment of the present disclosure will be described in detail with reference to the drawings. For example, the battery exchange cart of the present embodiment is used for exchanging the battery of a large vehicle such as a truck or a bus.

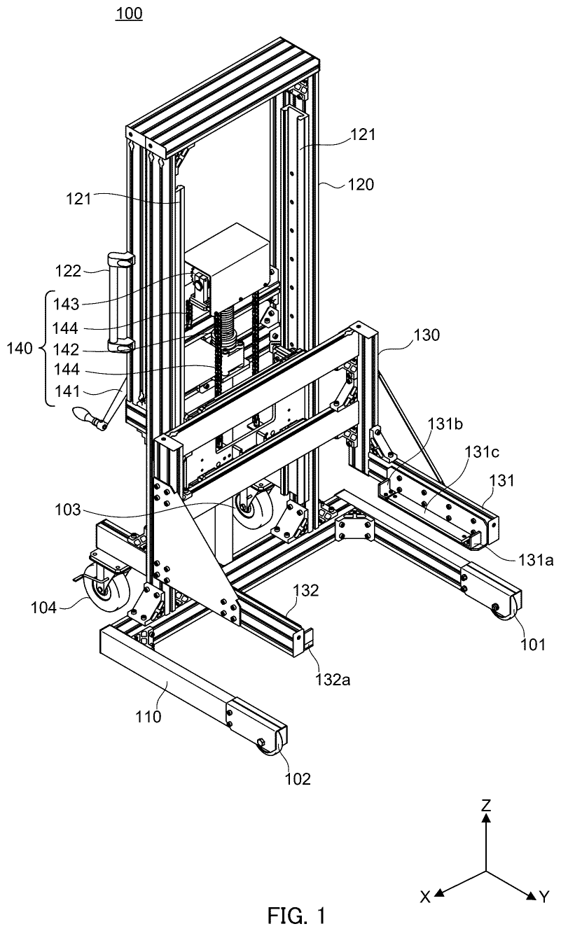

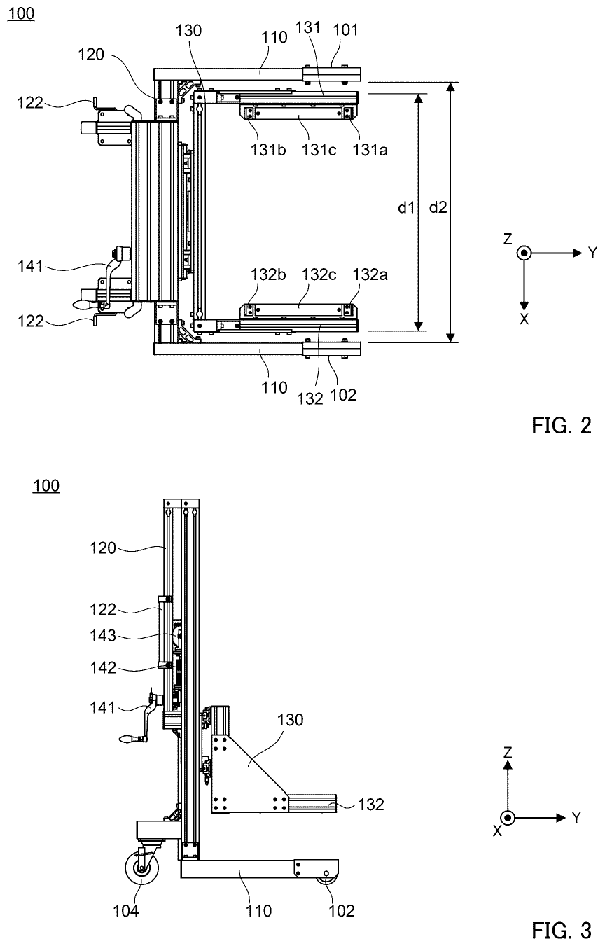

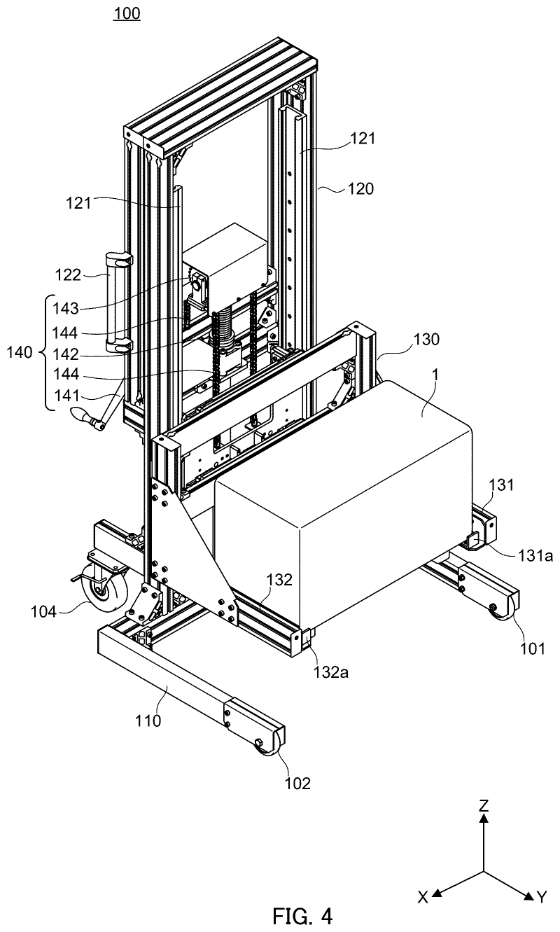

FIG. 1 is a perspective view illustrating a configuration of battery exchange cart 100 according to the present embodiment. FIG. 2 is a top view of battery exchange cart 100, and FIG. 3 is a side view of battery exchange cart 100. FIG. 4 is a perspective view illustrating a state in which battery exchange cart 100 is transporting battery 1.

Battery exchange cart 100 is moved when pushed by a worker. In the following description, the forward direction of battery exchange cart 100 is defined as the +Y direction, the backward direction as the −Y direction, the width direction of battery exchange cart 100 as the ±X direction, and the up-down direction (vertical direction) of battery exchange cart 100 as the ±Z direction.

Battery exchange cart 100 includes two front wheels 101 and 102 and two rear wheels 103 and 104. Wheels 101 to 104 are attached to bottom frame 110 and are rotatably supported by bottom frame 110.

Here, the distance between front wheel 101 and front wheel 102 is larger than the distance between rear wheel 103 and rear wheel 104. This increases the stability on the front side, and makes it possible to stably transport heavy battery 1 (FIG. 4). For example, the weight of battery 1 is approximately 180 kg. Naturally, the weight of battery 1 is not limited to this.

Battery exchange cart 100 includes vertical frame 120 that rises in the vertical direction (+Z direction) from bottom frame 110. Arm unit 130 is attached to vertical frame 120. Further, drive unit 140 is mounted on vertical frame 120.

Arm unit 130 is movably supported in the vertical direction (±Z direction) by guide rail 121 provided on vertical frame 120. Note that, as described later, in practice, linear motion guide 123 (FIG. 8) is attached to guide rail 121 in a movable manner in the vertical direction (±Z direction), and arm unit 130 is supported on vertical frame 120 in a movable manner in the vertical direction (±Z direction) via linear motion guide 123.

Arm unit 130 includes battery holding arms (hereinafter, simply referred to as “arms”) 131 and 132 that protrude forward (in the forward direction (+Y direction) of battery exchange cart 100) from vertical frame 120 and are capable of holding battery 1. Arms 131 and 132 are a pair of arms that face each other in the horizontal direction.

Locking claws 131a and 131b are provided on arm 131, and locking claws 132a and 132b are provided on arm 132. Mounting surface 131c for the battery is formed between locking claw 131a and locking claw 131b. Similarly, battery mounting surface 132c is formed between locking claw 132a and locking claw 132b.

As can be seen in the drawing, locking claws 131a, 131b, 132a, and 132b and mounting surfaces 131c and 132c are formed on surfaces of arm main bodies of arms 131 and 132 that face each other. Further, in the present embodiment, locking claws 131a, 131b, 132a, and 132b are disposed within the height range of the arm main body. Thus, as compared to a case where locking claws 131a, 131b, 132a, and 132b and mounting surfaces 131c and 132c are formed on the upper portion of the arm main body, the substantial thickness of arms 131 and 132 in the up-down direction can be reduced, and thus arms 131 and 132 can be easily inserted into the gap below battery 1, for example.

The arm width between arm 131 and arm 132, the interval between locking claw 131a and locking claw 131b, and the interval between locking claw 132a and locking claw 132b are set to match the size of battery 1 to be held. Thus, battery 1 is positioned and held at a predetermined position on arms 131 and 132 in a state in which movement in the +X direction is restricted by the surfaces of arms 131 and 132 that face each other, and movement in the #Y direction is restricted by locking claws 131a, 131b, 132a, and 132b.

Drive unit 140 includes steering wheel 141, screw jack part 142, movable pulley mechanism part 143, and chain 144. Movable pulley mechanism part 143 is supported by vertical frame 120 in a slidable manner in the up-down direction. Chain 144 has one end connected to vertical frame 120 and the other end connected to arm unit 130, with movable pulley mechanism part 143 therebetween.

When steering wheel 141 is rotated by the user, movable pulley mechanism part 143 is moved in the up-down direction (+Z direction) by screw jack part 142. For example, when steering wheel 141 is rotated in the clockwise direction, movable pulley mechanism part 143 is moved upward. In contrast, when steering wheel 141 is rotated in the counterclockwise direction, movable pulley mechanism part 143 is moved downward.

As movable pulley mechanism part 143 moves upward, arm unit 130 moves upward by being pulled by chain 144. Conversely, as movable pulley mechanism part 143 moves downward, arm unit 130 moves downward along with it.

In the present embodiment, movable pulley mechanism part 143 is configured to move arm unit 130 in the up-down direction by a distance twice the movement distance of movable pulley mechanism part 143 in the up-down direction. Note that, the distance is not limited to twice, and in short, movable pulley mechanism part 143 only needs to be configured to move arm unit 130 by a distance greater than the movement distance of arm unit 130 in the up-down direction.

As a result, the movement distance of arm unit 130 in the up-down direction for the operation of steering wheel 141 is large, and thus the burden on the user to move arm unit 130 in the up-down direction can be reduced.

Further, in the present embodiment, as can be seen from FIG. 2, arm width d1 between the pair of arms 131 and 132 is smaller than wheel width d2 between the pair of front wheels 101 and 102. More specifically, distance d1 (that is, the arm width) between the outer side of arm 131 and the outer side of arm 132 is smaller than distance d2 (that is, the wheel width) between the inner side of front wheel 101 and the inner side of front wheel 102. Thus, arms 131 and 132 fit into the space between front wheels 101 and 102 and bottom frame 110. As a result, arms 131 and 132 can be lowered to the position of the battery mounting surface.

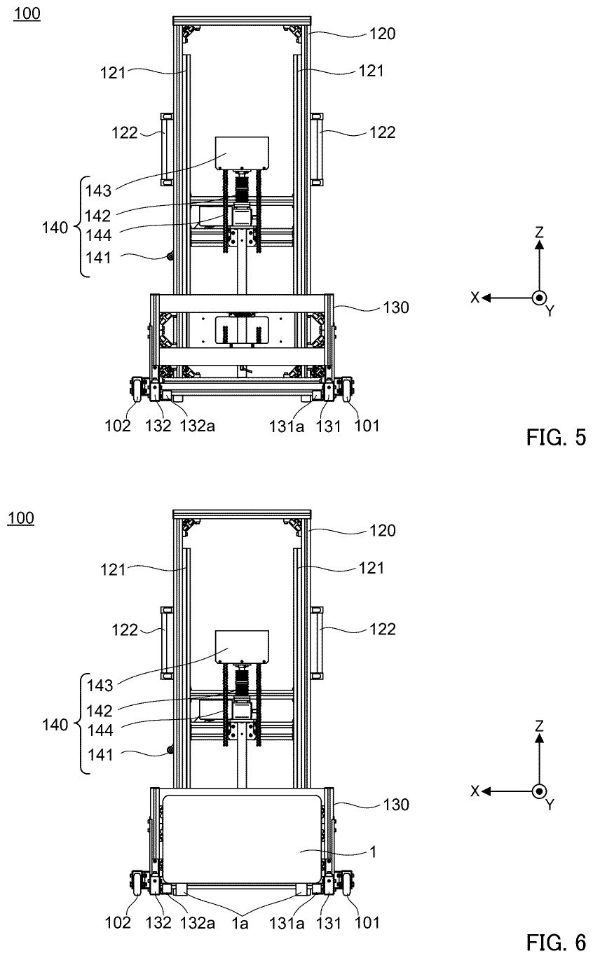

FIG. 5 is a front view of battery exchange cart 100 in a state where arm unit 130 is lowered to the lowermost position. As can be seen from FIG. 5, with arm width d1 smaller than wheel width d2, arms 131 and 132 can be lowered to the position of the battery mounting surface without interference with front wheels 101 and 102.

FIG. 6 is a front view of battery exchange cart 100 in a state where arms 131 and 132 are inserted below battery 1. Leg 1a is provided on the lower surface of battery 1, and thus there is a gap equal to the height of leg 1a between the lower surface of battery 1 and the battery mounting surface. Arms 131 and 132 are inserted into this gap.

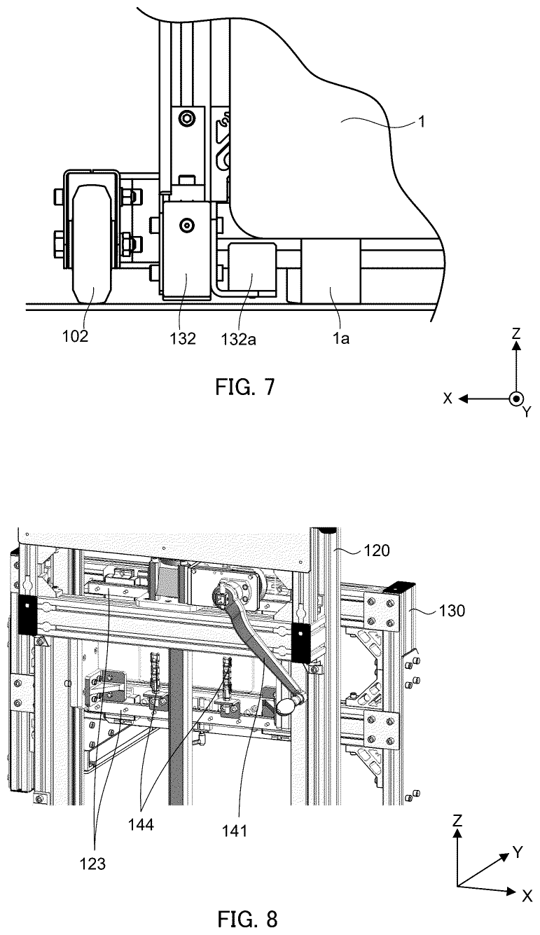

FIG. 7 is an enlarged view illustrating a state in which arms 131 and 132 are inserted into a gap between the lower surface of battery 1 and the battery mounting surface. As can be seen from FIG. 7, arm 132 (131) is lowered to a position very close to the battery mounting surface. Note that the height of locking claw 132a (131a) is lower than the height of leg 1a.

Note that, in a case where the height of leg 1a is higher than the height of front wheels 101 and 102, the gap between the lower surface of battery 1 and the battery mounting surface is large, and it is considered that battery 1 can be lifted even if the height of arms 131 and 132 is higher than the height of front wheels 101 and 102, for example. However, disadvantageously, the higher the height of leg 1a, the more unstable battery 1 becomes. With the configuration of the present embodiment, battery 1 can be lifted without encountering such a disadvantage.

In addition to the above configuration, arm unit 130 is supported on vertical frame 120 such that arm unit 130 is movable in the horizontal direction (+X direction) perpendicular to the traveling direction (+Y direction) of battery exchange cart 100. As described above, by configuring arm unit 130 in a movable manner not only in the up-down direction (+Z direction) but also in the horizontal direction (+X direction) perpendicular to the traveling direction, it is possible to reduce the effort of the user for alignment when placing battery 1 on battery exchange cart 100 and when loading battery 1 onto a vehicle.

FIG. 8 is a perspective view of battery exchange cart 100 as viewed from an obliquely rear side. Linear motion guide 123 that extends in the +X direction is provided on vertical frame 120. Arm unit 130 is supported by linear motion guide 123 in a slidable manner in the +X direction. Here, linear motion guide 123 is supported on vertical frame 120 in a movable manner in the up-down direction, and is moved in the up-down direction via movable pulley mechanism part 143.

That is, arm unit 130 is supported on vertical frame 120 such that arm unit 130 is movable in the up-down direction (±Z direction) and is movable in the horizontal direction (±X direction) perpendicular to the traveling direction (±Y direction) of battery exchange cart 100. Note that arm unit 130 in the +X direction is manually moved by the user.

Next, the operation of battery exchange cart 100 will be described.

First, the user operates steering wheel 141 to lower arm unit 130 to the lowermost position. Next, the user pushes battery exchange cart 100 forward (+Y direction) by holding gripping part 122 provided on vertical frame 120, thereby inserting arms 131 and 132 into the gap between the lower surface of battery 1 and the battery mounting surface as illustrated in FIG. 7.

Next, the user raises arm unit 130 by operating steering wheel 141. Thus, as illustrated in FIG. 4, battery 1 is positioned and held at a predetermined position on arms 131 and 132. In this state, the user transports battery 1 to the vehicle in which battery 1 is mounted.

The user moves battery exchange cart 100 such that battery 1 is positioned above the battery mounting position of the vehicle. Here, for the alignment to the battery mounting position, it is necessary to align the position in the +Y direction with the position in the +X direction. In the present embodiment, arm unit 130 can be moved in the +X direction with respect to the main body of battery exchange cart 100, and thus the alignment to the battery mounting location can be easily performed.

For example, with a configuration in which arm unit 130 cannot be moved in +X direction with respect to the main body of battery exchange cart 100, if the position in the +X direction is shifted, it is necessary to adjust the position in the +X direction while moving battery exchange cart 100 backward and forward many times, which requires a lot of effort for alignment. In contrast, the configuration of the present embodiment can reduce the effort required for this alignment.

After the alignment to the battery mounting position, the user operates steering wheel 141 to lower arm unit 130. In this manner, battery 1 is mounted at a predetermined position in the vehicle.

As described above, battery exchange cart 100 of the present embodiment includes: wheels 101 to 104 including at least rear wheels 103 and 104 and front wheels 101 and 102; a bottom frame 110 that connects wheels 101 to 104 to each other; a vertical frame 120 that rises in the vertical direction from bottom frame 110; and an arm unit 130 including battery holding arms 131 and 132 that protrude forward (+Y direction) from vertical frame 120 and are capable of holding battery 1. Arm unit 130 is supported on vertical frame 120 in a movable manner in an up-down direction (+Z direction) and in the horizontal direction (+X direction) perpendicular to the traveling direction (+Y direction) of battery exchange cart 100.

Thus, battery exchange cart 100 suitable for battery exchange can be realized.

The embodiments described above are no more than specific examples in carrying out the present invention, and the technical scope of the present invention is not to be construed in a limitative sense due to the specific examples. That is, the present invention can be carried out in various forms without departing from the spirit and the main features thereof.

In the above-described embodiment, an example in which battery exchange cart 100 is used to mount battery 1 on a vehicle has been described, but battery exchange cart 100 may be used to remove battery 1 mounted on a vehicle and transport battery 1, or to only transport battery 1.

In the above-described embodiment, a case where screw jack part 142 is provided and movable pulley mechanism part 143 is moved in the up-down direction by using screw jack part 142 has been described, but the means for moving movable pulley mechanism part 143 in the up-down direction is not limited to screw jack part 142. For example, a hydraulic mechanism or the like may be used to move movable pulley mechanism part 143 in the up-down direction.

Steering wheel 141 in the above-described embodiment may be operated by the user directly by hand or may be operated using a tool such as an impact wrench.

### INDUSTRIAL APPLICABILITY

The present disclosure is widely applicable as a battery exchange cart used for exchanging a battery of a vehicle.

### REFERENCE SIGNS LIST

1 Battery
1a Leg
100 Battery exchange cart
101, 102 Front wheel
103, 104 Rear wheel
110 Bottom frame
120 Vertical frame
121 Guide rail
122 Gripping part
123 Linear motion guide
130 Arm unit
131, 132 Arm
131a, 131b, 132a, 132b Locking claw
131c, 132c Mounting surface
140 Drive unit
141 Steering wheel
142 Screw jack part
143 Movable pulley mechanism part
144 Chain

1. A battery exchange cart used for exchanging a battery, the battery exchange cart comprising:
wheels including at least a rear wheel and a front wheel;
a frame part including:
a bottom frame configured to connect between the wheels, and
a vertical frame provided upright in a vertical direction from the bottom frame; and
an arm unit including a battery holding arm protruding forward from the vertical frame and configured to hold a battery,
wherein the arm unit is supported by the vertical frame in a movable manner in an up-down direction and in a horizontal direction perpendicular to a traveling direction of the battery exchange cart.

2. The battery exchange cart according to claim 1,
wherein the battery holding arm is a pair of arms facing each other in the horizontal direction,
wherein the pair of arms includes a locking claw configured to lock the battery, and
wherein the locking claw is formed on opposite surfaces of the pair of arms facing each other.

3. The battery exchange cart according to claim 1,
wherein the battery holding arm includes a pair of arms,
wherein the front wheel includes a pair of front wheels, and
wherein an arm width is smaller than a wheel width, the arm width being a distance between the pair of arms, the wheel width being a distance between the pair of front wheels.

4. The battery exchange cart according to claim 1, further comprising a movable pulley mechanism part configured to move the arm unit in the up-down direction.

5. The battery exchange cart according to claim 4, wherein the movable pulley mechanism part is attached to the vertical frame in a movable manner in the up-down direction, and is configured to move the arm unit by a distance greater than a movement distance of the movable pulley mechanism part in the up-down direction.
